(19) United States
(12) Patent Application Publication
(10) Pub. No.: US 2015/0199987 A1
(43) Pub. Date: Jul. 16, 2015

(54) SYSTEM AND METHOD FOR NFT PROTRUSION COMPENSATION

(71) Applicant: HGST Netherlands B.V., Amsterdam (NL)

(72) Inventors: Sripathi Vangipuram CANCHI, San Jose, CA (US); Bruno MARCHON, Palo Alto, CA (US); Remmelt PIT, Menlo Park, CA (US); Erhard SCHRECK, San Jose, CA (US)

(73) Assignee: HGST Netherlands B.V., Amsterdam (NL)

(21) Appl. No.: 14/156,253

(22) Filed: Jan. 15, 2014

(51) Int. Cl. G11B 5/60

(52) U.S. Cl. CPC G11B 5/6052; G11B 2005/0021

(57) ABSTRACT

Embodiments described herein generally relate to method of maintaining the flying height of a head during a write operation. Methods described herein disclose the application of an electrical bias to create a coulomb force between the head and the magnetic disk. The bias is applied such that the write operation is not affected and a touchdown from the transient extension of the near field transducer is prevented.

### BACKGROUND OF THE INVENTION

1. Field of the Invention

Embodiments described herein generally relate to methods for controlling flying height of a head.

2. Description of the Related Art

Hard disk drives (HDD) include read and write transducers that reside within a slider, which flies over a recording media/disk. Increasing demand in data density requires that the read and write transducers fly closer to the media. As flying heights diminish, it becomes more relevant to accurately control the head-disk distance (i.e., the distance between the read-write heads and the disk). Accordingly, the fly-height between the slider and disk is increasingly important as storage densities also increase.

Heat assisted magnetic recording (HAMR) generally refers to the concept of locally heating a recording media to reduce the coercivity of the media so that an applied magnetic writing field can more easily direct the magnetization of the media during the temporary magnetic softening of the media caused by the heat source. This technique is broadly referred to as “thermally assisted (magnetic) recording” (TAR or TAMR), “energy assisted magnetic recording” (EAMR), or HAMR which are used interchangeably herein. A tightly confined, high power laser light spot is used to heat a portion of the recording media to substantially reduce the coercivity of the heated portion. In one approach, a beam of light is condensed to a small optical spot on the storage medium using a near field transducer (NFT) to heat a portion of the medium and reduce the magnetic coercivity of the heated portion. Then, the heated portion is subjected to a magnetic field that sets the direction of magnetization of the heated portion. In this manner, the coercivity of the media at ambient temperature can be much higher than the coercivity during recording, thereby enabling stability of the recorded bits at much higher storage densities and with much smaller bit cells.

The NFT is designed to reach local surface-plasmon resonance at a designed light wavelength. The surface plasmon is excited in a small conducting antenna that is incorporated within the read/write head structure. At resonance, a high electric field surrounding the NFT appears, due to the collective oscillation of electrons in the metal. A portion of the field will tunnel into a storage medium and get absorbed, raising the temperature of the medium locally for recording.

As the plasmon antenna heats up due to the absorption of optical energy from the laser, it very quickly (approximately 50 μs to 100 μs) creates a transient protrusion which protrudes from the surface of the read/write head and approaches the medium surface. In principle, the thermal response of the thermal flying height control (TFC) element can compensate for the transient protrusion by slightly lifting the head away from the disk surface to increase fly height. However, the time constant for transient protrusion is less by a factor between 10 and 50 than the time constant for TFC response so the TFC element cannot adequately compensate for the antenna protrusion. This large difference in response times leads to a transient protrusion at the beginning of a write process which can lead to head/disk interference.

Thus, there is a need for better control of flying height in magnetic recording devices.

### SUMMARY OF THE INVENTION

Embodiments described herein generally relate to controlling the flying height of a head during operation. In one embodiment, a method for controlling flying height can include positioning a head at a flying height which is a first distance from a magnetic disk, the head comprising a near field transducer; applying a voltage to the head or the magnetic disk, the voltage changing the flying height between the head and the magnetic disk from the first distance to a second distance; delivering a radiation to the magnetic disk through the near field transducer, the radiation heating the near field transducer and changing the flying height from the second distance to a third distance; and altering the voltage to the head to change the flying height to the second distance.

In another embodiment, a method for controlling flying height can include delivering an electrical bias to a head, the head comprising a first surface facing a magnetic disk and a near field transducer positioned at the first surface at a first distance from the magnetic disk; delivering radiation to the magnetic disk through the near-field transducer, the near field transducer changing shape in response to the radiation, wherein the near field transducer is positioned at a second distance from the magnetic disk; and reducing the electrical bias to the head to move the near field transducer to a third distance from the magnetic disk.

In another embodiment, a system for controlling flying height can include at least one processing unit. The processing unit is adapted to perform steps including positioning a head at a flying height which is a first distance from a magnetic disk, the head comprising a near field transducer, applying a voltage to the head, the voltage changing the flying height between the head and the magnetic disk from the first distance to a second distance, delivering a radiation to the magnetic disk through the near field transducer, the radiation heating the near field transducer and changing the flying height from the second distance to a third distance and altering the voltage to the head to change the flying height to the second distance.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating a configuration of a magnetic disk apparatus, according to one embodiment;

FIGS. 2A-2C are cross sectional schematic illustrations of a HAMR enabled write head, according to one embodiment;

FIG. 3 is a block diagram of a method for controlling flying height of a HAMR head, according to one embodiment; and

FIG. 4 is a chart 400 illustrating the relationship, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Embodiments described herein generally relate to controlling the flying height of a head during a writing operation. More specifically, embodiments relate to controlling the flying height of a HAMR head with relation to transient changes in the air bearing surface. The NFT in HAMR recording has a transient protrusion time constant much faster than the flying height accommodation provided by many TFC elements. The speed of the NFT transient protrusion inhibits adequate compensation at write start. By controlling the flying height of the slider either fully or partially through electrostatic effects, the NFT transient protrusion can be compensated for in a near instantaneous fashion. The methods described herein adjust the flight height of NFT element using an electrostatic control mechanism generating a physical force through electrostatic induction. In this way, the speed of actuation is only limited by the air bearing P2 frequency. Therefore, NFT time constants of the order of 50-100 us can be compensated. Embodiments disclosed herein are more clearly described with reference to the figures below.

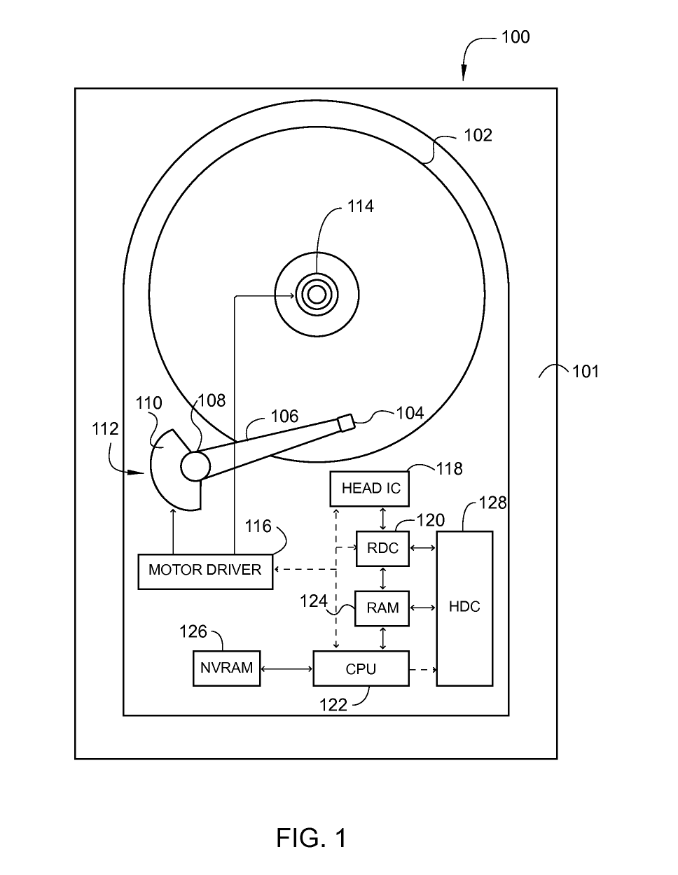

FIG. 1 is a schematic diagram illustrating a configuration of a magnetic disk apparatus (hereinafter also referred to as a “HDD”) 100, according to one embodiment. The HDD 100 is an electronic device that communicates with a host system (not shown). The HDD 100 according to the present embodiment has a mechanism structure including a magnetic disk 102, a slider 104, an arm 106, a bearing 108; a VCM (Voice Coil Motor) 110 and an SPM (Spindle Motor) 114. The slider 104, the arm 106, the bearing 108 and the VCM 110 integrally constitute a structure that is referred to as an HSA (Head Stack Assembly) 112. Further, the HDD 100 includes functional blocks of a circuit system, such as a motor driver 116, a head IC 118, a read/write channel IC (hereinafter also referred to as an “RDC”) 120, a CPU 122, a RAM 124, an NVRAM 126, and an HDC (Hard Disk Controller) 128.

The HDD 100 according to the present embodiment supplies a driving current to the VCM 110, thereby rotating the HSA 112 using the bearing 108 as a rotation center. A rotation angle of the HSA 112 is limited to a given range. An adherent substance might be adhered to a part of the slider 104. The HDD 100 supplies a driving current to the VCM 110 and thus rotates the HSA 112, thereby removing the adherent substance from the slider 104. In many cases, the adherent substance is lubricating oil or the like applied onto the magnetic disk.

The magnetic disk 102 is fixed to the SPM 114, and is rotated by driving the SPM 114. At least one surface of the magnetic disk 102 serves as a recording surface on which information is magnetically recorded.

The slider 104 is provided at one end of the arm 106 so as to be associated with the recording surface of the magnetic disk 102. The read head on the slider 104 reads a signal magnetically recorded on the recording surface of the magnetic disk 102, and outputs the read signal to the head IC 118. Furthermore, in response to a write signal (write current) fed from the head IC 118, the write head on the slider 104 magnetically records information on the recording surface of the magnetic disk 102. The slider 104 slides over the recording surface of the magnetic disk 102.

The arm 106 is provided at its one end with the slider 104. In response to the supply of a driving current to the VCM 110, the arm 106 rotates using the bearing 108 as a rotation center, and moves the slider 104 radially over the recording surface of the magnetic disk 102.

The bearing 108 serves as the rotation center of the HSA 112 by inserting a shaft (not shown) to be fixed to an enclosure of the HDD 100. The VCM 110 is driven in response to a driving signal (current) supplied from the motor driver 116, thereby rotating the arm 106 on the shaft. The HSA 112 is the structure integrally constituted by the slider 104, the arm 106, the bearing 108 and the VCM 110. In response to the supply of a driving current to the VCM 110, the HSA 112 moves the slider 104, provided at one end of the arm 106, using the bearing 108 as the rotation center. The rotation angle of the HSA 112 is limited to a given range.

The SPM 114 is driven in response to a driving signal (current) supplied from the motor driver 116, thereby rotating the magnetic disk 102. Based on control carried out by the CPU 122, the motor driver 116 supplies, to the VCM 110 and the SPM 114, the driving signals for driving the VCM 110 and the SPM 114, respectively.

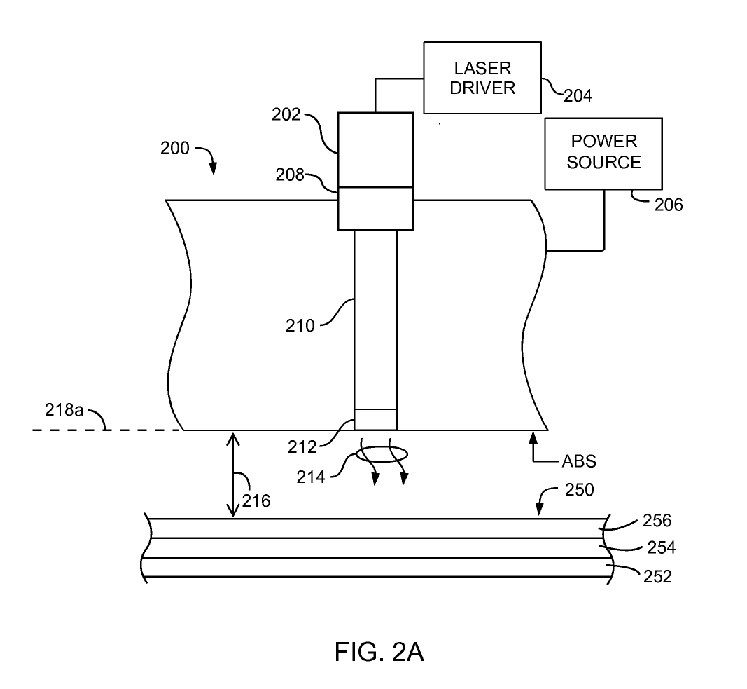

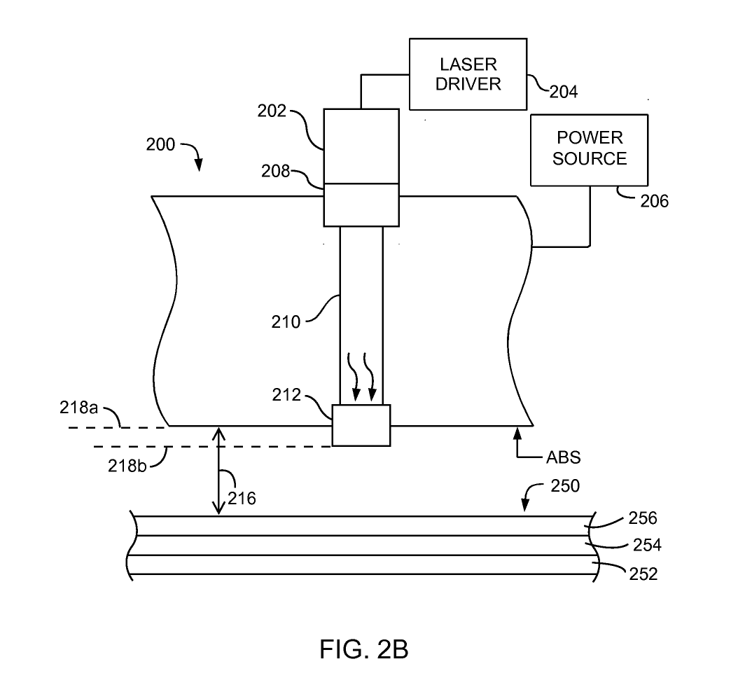

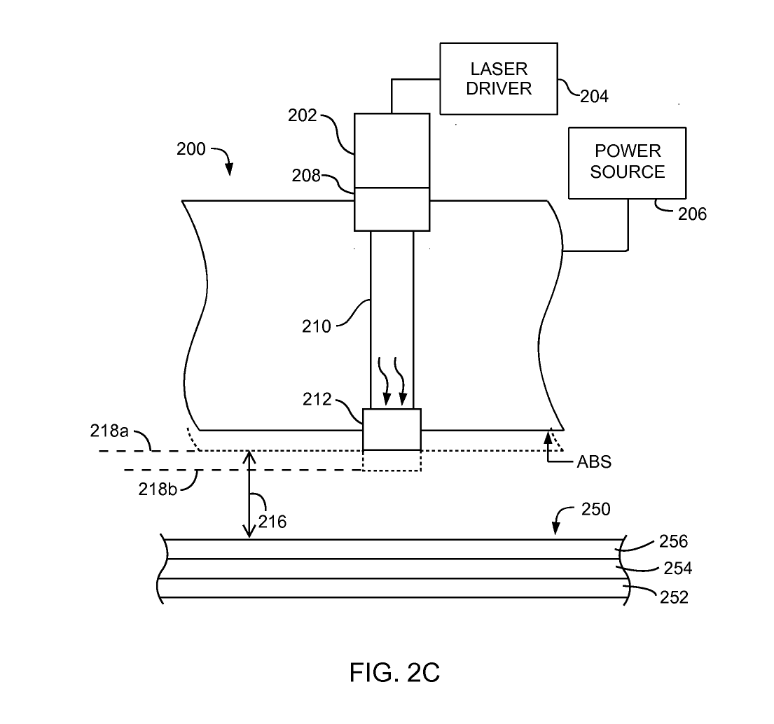

The head IC 118 amplifies a signal fed from a read head (not shown) provided at the slider 104, and outputs, as read information, the amplified signal to the RDC 120. Further, the head IC 118 outputs, to a write head (shown in FIG. 2) provided at the slider 104, a write signal (write current) responsive to recording information fed from the RDC 120.

The RDC 120 performs a given process on the read information, fed from the head IC 118, to decode the read information, and outputs, as transfer information, the decoded information to the HDC 128. Furthermore, the RDC 120 performs a given process on information, which has been fed from the HDC 128 and should be recorded, to encode the information, and outputs, as recording information, the encoded information to the head IC 118. The RDC 120 utilizes the RAM 124 as a work memory in performing the given processes for encoding and decoding. The RAM 124 is a work memory for the RDC 120, the CPU 122 and the HDC 128. In one embodiment, the RAM 124 is a DRAM serving as a volatile memory.

The NVRAM 126 is a nonvolatile memory for storing a program executed by the CPU 122. The program stored in the NVRAM 126 is updatable. In accordance with a program stored in the NVRAM 126, the CPU 122 controls each block included in the HDD 100. The CPU 122 is a processor for controlling rotational operations of the VCM 110 and the SPM 114. The CPU 122 utilizes the RAM 124 as a work memory in executing the program. In the present embodiment, with the aim of removing an adherent substance adhered to the slider 104, the CPU 122 performs control so as to rotate the VCM 110 to a position at which the adherent substance does not interfere with the recording surface of the magnetic disk 102. This control is carried out using given timing as a trigger.

The HDC 128 carries out a communication process for transmitting and receiving information to and from the host system 150. The HDC 128 performs a given process on the transfer information, fed from the RDC 120, to encode the transfer information, and transmits, as transmission information, the encoded information to the host system 150. Moreover, the HDC 128 performs a given process on reception information, received from the host system 150, to decode the reception information, and outputs, as information that should be recorded, the decoded information to the RDC 120. For example, the HDC 128 carries out the communication process with the host system 150 in accordance with a SATA (Serial Advanced Technology Attachment) standard.

The above description of a typical magnetic disk storage system and the accompanying illustration are for representation purposes only. It should be apparent that disk storage systems may contain a large number of disks and actuators, and each actuator may support a number of sliders.

FIGS. 2A-2C are cross sectional schematic illustrations of a HAMR enabled write head 200, according to one embodiment. The head 200 is operatively attached to a radiation source 202 that is powered by a radiation driver 204. The radiation source 202 may be placed directly on the head 200 or radiation may be delivered from a radiation source 202 located off the slider through an optical fiber or waveguide. Similarly, the radiation driver 204 circuitry may be located on the slider 104 or on a system-on-chip (SOC) associated with the disk drive 100. The head 200 includes a spot-size converter 208 for focusing the radiation transmitted by the radiation source 202 into a waveguide 210. In another embodiment, the disk drive 100 may include one or more lens for focusing the radiation of the radiation source 202 before the emitted radiation reaches the spot-size converter 208.

The waveguide 210 is a channel that transmits the radiation through the height of the head 200 to the near-field transducer 212—e.g., a plasmonic device—which is located at or near the air-bearing surface (ABS). The near-field transducer 212 further focuses the beamspot to avoid heating neighboring tracks of data on a magnetic disk 250—i.e., creates a beamspot much smaller than the diffraction limit. As shown by arrows 214, this optical energy emits from the near-field transducer 212 to the surface of the magnetic disk 250 below the ABS of the head 200. The embodiments herein are not limited to any particular type of near-field transducer and may operate with, for example, either a c-aperture, e-antenna plasmonic near-field source, or any other shaped transducer.

The magnetic disk 250 is positioned adjacent to or under the head 200. The magnetic disk 250 includes a substrate 252, which may be made of any suitable material, such as ceramic glass or amorphous glass. A soft magnetic underlayer 254 is deposited on the substrate 252. The soft magnetic underlayer 254 may be made of any suitable material such as, for example, alloys or multilayers having Co, Fe, Ni, Pd, Pt or Ru. A hard magnetic recording layer 256 is deposited on the soft underlayer 254, with the perpendicular oriented magnetic domains contained in the hard layer 256. Suitable hard magnetic materials for the hard magnetic recording layer 256 can include at least one material having a relatively high anisotropy at ambient temperature, such as FePt or CoCrPt alloys.

A power source 206 is shown here as connected to the head 200. The power source 206 can provide a bias to the head 200, which creates a Coulomb force between the head 200 and the magnetic disk 250 (which is referred to hereafter as interface voltage control). Though shown here as biasing the head 200 to create the interface voltage control, the bias may also be applied to the magnetic disk 250. The Coulomb force between two or more charged bodies is the force between them due to Coulomb's law. If the charged bodies are both positively or negatively charged, the force is repulsive. If the charged bodies are of opposite charge, the force is attractive. The Coulomb force created between the head 200 and the magnetic disk 250 counterbalances the opposing force created by the air under the air bearing surface during the rotation of the disk, the force applied by the arm 106, the forces above as augmented by a TFC element or other lifting forces on the head 200.

The head 200 directs the radiation source 202 to heating the magnetic disk 250 proximate to where the write pole applies the magnetic write field to the magnetic disk 250. The transmitted radiant energy, generally designated by arrows 214, is delivered through the near-field transducer 212 to the surface of the magnetic disk 250 for heating a localized area of the magnetic disk 250, and particularly for heating a localized area of the hard magnetic layer 256.

During operation of a HAMR/TAR enabled head 200, the rotation of the magnetic disk 250 generates an air cushion between the ABS of the slider 104 and the surface of the magnetic disk 250 which exerts an upward force or lift on the head 200. The air flow thus counter-balances the slight spring force of the arm 106, shown with reference to FIG. 1, and the force created by the interface voltage control at the head 200. The counter-balanced forces support the head 200 off and slightly above the magnetic disk 250 surface by a small, substantially constant spacing during normal operation, which is denoted by a distance 216. The radiation source 202, through the NFT 212, heats up the high-coercivity data bits so that the write elements of the head 200 may correctly magnetize the data bits. Upon receiving radiation from the radiation source 202, the near-field transducer 212 heats up, which causes the NFT 212 to expand toward the surface of the magnetic disk 250. This expansion reduces the spacing between the NFT 212 and the magnetic disk 250.

In FIG. 2B, the head 200 is depicted with localized heating from the radiation source 202, according to one embodiment. Proportions and positioning of certain components of the head 200 are exaggerated for clarity. The positioning and proximity of the head 200 generally is meant to be viewed generally and is not limiting of possible embodiments. As described above, the head 200 has an air bearing surface which is positioned at a specific flying height above the magnetic disk, depicted as height 218a. At the beginning of write operations, the NFT 212 will receive radiation from the radiation source 202 and heat up. The heating of the NFT 212 will cause the NFT 212 to expand. The distance of the expansion away from the air bearing surface is depicted here as height 218b, which is the height 218a as reduced by the expansion of the NFT 212 from the air bearing surface. Thus, the flying height of the head 200 as compared to the magnetic disk 250 will be changed, which can lead to touchdown (TD). Once there is a TD, the area on the magnetic disk 250 where the contacting took place may not be used for storing data and may be damaged causing loss of data. Additionally, unintended contact may cause damage to the read/write head.

FIG. 2C depicts a head 200 using an interface voltage control, according to one embodiment. In this embodiment, the power source 206 delivers a bias to the head 200, which reduces the flying height of the head 200 to the height 218a. As the radiation source 202 delivers radiation through the NFT 212, the NFT 212 is heated and thus expands. Though only the NFT 212 is shown expanding, it is understood that nearby components will equilibrate with the NFT 212 and will also expand.

The interface voltage control through the power source 206 acts in conjunction with the actuator arm, the TFC and other flying height control elements to maintain a constant height. To prevent the expansion of the NFT 212 and other components from reducing the overall flying height of the head 200, the power source 206 reduces the charge delivered to the head 200. This reduced charge increases the flying height of the head 200, as the interface voltage control at the head 200 from the power source 206 creates an attractive force (e.g. Coulomb force) which counterbalances against other forces involved with the flying height of the head 200.

The Coulomb force from the interface voltage control is time responsive on the order of μs, allowing changes in flying height over a time period ranging from 2 μs to 5 μs. The speed of actuation is only limited by the air bearing surface P2 (Pitch 2) frequency. The ABS surface is typically designed with two pitch nodal lines, designated P1 (Pitch 1) and P2 (Pitch 2), at which the ABS rotates in a pitch direction relative to the air flow. Further, based on the dynamics of rigid body motion, each pitch nodal line corresponds to a particular frequency of vibration of the slider. This frequency limits the speed of interface voltage control response. In one embodiment, the P2 frequency is above 200 kHz, leading to an interface voltage control response time of 5 μs or less. In another embodiment, the P2 frequency is less than 400 kHz, leading to an interface voltage control response time of 2 μs or greater. Since, the NFT time constants for expansion are between 50 μs and 100 μs, the interface voltage control can be adjust in real time to respond to changes in temperature in the near-field transducer 212.

The interface voltage control voltage can be between −2V and 2V. In one embodiment, the interface voltage control voltage applied to the head 200 is about −0.5V. The voltage applied from the power source 206 can either be a direct current (DC) or an alternating current (AC). When using AC, the AC frequency should be much higher than the P2 frequency, such as a 10 fold increase or greater over the P2 frequency. To determine the flying height of the head 200, the head 200 further includes an ECS (not shown). To control the head/disk clearance, a relationship between the signal from the ECS and the head/disk clearance is calculated.

The change in flying height can be determined by subtracting the flying height 218a from the flying height 218b. The head 200 is then repositioned such that the transient extension from the near-field transducer 212 is at the flying height 218a. The temperature of the NFT 212 is expected to equilibrate with nearby components over longer period of time, thus leading to expansion of the nearby components. During shorter operations, the NFT 212 is expected to cool quickly after the radiation source 202 is turned off and based on air flow at the air bearing surface. In either case, the extension of the near-field transducer is expected to be transient. The interface voltage control may be used to maintain the flying height 218a during the entire operation of the magnetic disk 250 and head 200, such as during any operations requiring a constant flying height. The interface voltage control may be used to maintain the flying height 218a only during a portion of the operation of the magnetic disk 250 and head 200, such as only during write operations or only during the initial radiation delivery of a HAMR/TAR write operation. Further, the interface voltage control can act in conjunction with or in the absence of the TFC.

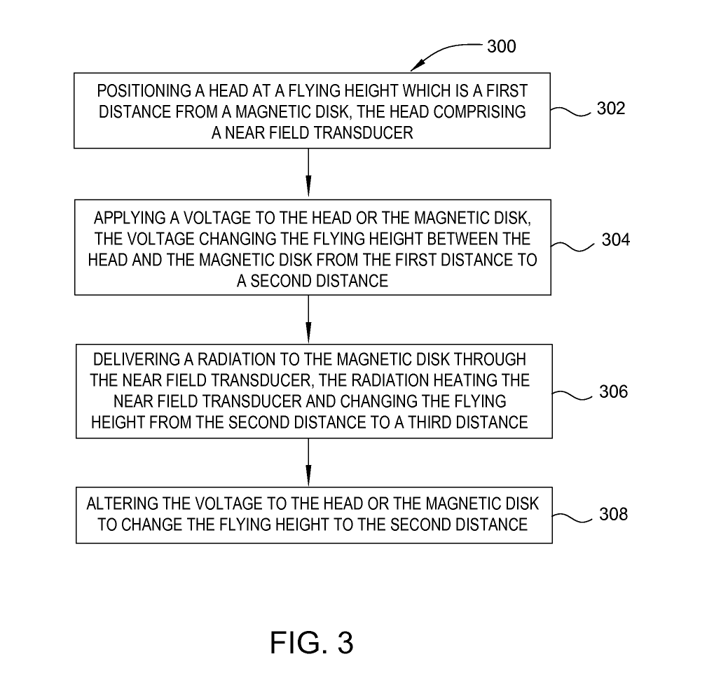

FIG. 3 is a block diagram of a method 300 for controlling flying height of a HAMR head, according to one embodiment. The method 300 includes positioning a head at a flying height which is a first distance from a magnetic disk, the head comprising a NFT, at element 302; applying a voltage to the head or magnetic disk, the voltage changing the flying height between the head and the magnetic disk from a first distance to a second distance, at element 304; delivering a radiation to the magnetic disk through the NFT, the radiation heating the NFT and changing the flying height from the second distance to a third distance, at element 306; and altering the voltage to the head or the magnetic disk to change the flying height to the second distance, at element 308.

The head and the slider are positioned at the flying height which is a first distance from a magnetic disk, at element 302. The first distance is a flying height which is created by a combination of the air flowing under the air bearing surface, the TFC, the actuator arm and other factors which act in conjunction to create the initial height. The first distance may be a distance from the magnetic disk which is slightly higher than an appropriate flying height for a head, such as between 1 nm and 10 nm. The head includes one or more components, such as the NFT, depicted with reference to FIG. 1 and FIGS. 2A-2C.

At element 304, a plurality of interface voltages are applied to the head or the magnetic disk to bias either the head, the magnetic disk or combinations thereof. The interface voltages applied cause a coulomb attraction and affect the spacing between the head and the magnetic disk. The plurality of interface voltages may cause a plurality of changes in the head/disk clearance (e.g., the first distance). The interface voltages may be applied to the magnetic disk or to the head, and may have a range between −2 V to 2 V. In further embodiments, the flying height can be modified by an interface voltage control from the first distance to the second distance or the interface voltage control can supplant one or more of the above factors in modifying the first distance to the second distance.

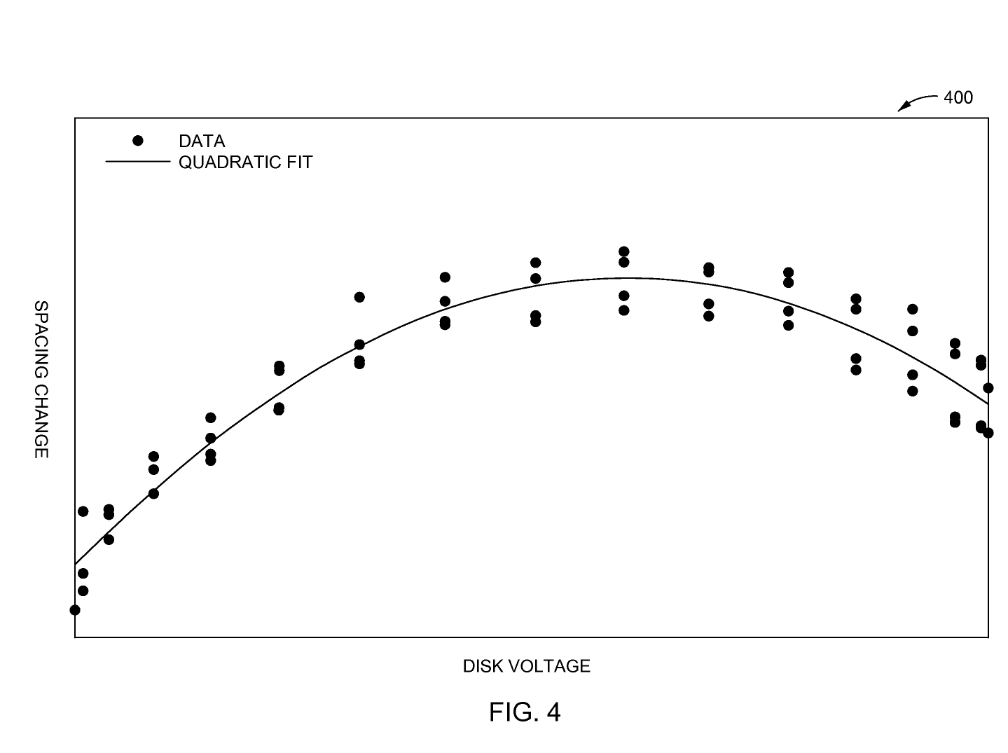

Next, the change in head/disk clearance for each interface voltage applied to the disk is calculated. The calculation may be based on any suitable technique, such as techniques based on Wallace Spacing Loss relationship, where the change in amplitude of the measured read-back signal harmonics directly relate to the head/disk clearance change. If a TD is performed, the actual head/disk clearance may be obtained. FIG. 4 is a chart 400 illustrating the relationship, according to one embodiment. The interface voltages are applied to the magnetic disk. For each data point, the power applied to the TFC element remains constant. The relationship between the change in head/disk clearance and the interface voltage applied to the disk may change if the power applied to the TFC element changes.

Then, a radiation is delivered through the NFT to the magnetic disk, at element 306. As described above, the radiation delivered through the NFT heats the NFT simultaneously. Thus, there is a transient extension of the NFT from the air bearing surface, which reduces the second distance to a third distance. The transient extension can be less than 2 nm, such as less than 1 nm. The third distance is the second distance as changed by the transient extension of the NFT. The third distance is directly related to the temperature of the NFT and the material composition of the NFT. Thus, the amount of expansion, and thereby the third distance, can be determined based on empirical data and temperature measurement.

At element 308, the interface voltages delivered to the head and/or the magnetic disk are altered to reposition the head including the transient extension. Using the correlation between voltage and flying height, the voltage of either the head or the magnetic disk can be adjusted to reposition the head including the transient extension at the second distance. The adjustment of the voltage may be continuous to maintain the transient extension at the second distance during expected changes in the head, such as based on heating of components of the head or slider which might affect flying height or based on changes in the transient extension itself.

As the transient extension is expected to occur within 50-100 μs of receiving the radiation from the radiation source, it is believed that the accommodation can occur at a variety of time points around or in that time frame. In one embodiment, the interface voltages are modulated at a time point prior to the transient extension or simultaneous with the transient extension. Further, one or more of the interface voltages may be changed, either up or down, such that the overall flying height change results in the transient extension being at the second distance from the magnetic disk. The interface voltages may be used transiently, such as the interface voltages accommodating for the flying height changes until the thermal height control can accommodate during longer write cycles.

In another embodiment, a method for controlling flying height can include delivering an electrical bias to a head, delivering radiation to the magnetic disk through the near-field transducer, the NFT changing shape in response to the radiation, wherein the NFT is positioned at a second distance from the magnetic disk, and reducing the electrical bias to the head to move the NFT to a third distance from the magnetic disk. The head can include a first surface facing a magnetic disk and a NFT positioned at the first surface at a first distance from the magnetic disk.

In a further embodiment, a system is adapted to control the flying height of the slider using the method 300 described above. The system can include at least one processing unit. The processing unit can be adapted to perform steps including positioning a head at a flying height which is a first distance from a magnetic disk, the head comprising a near field transducer; applying a voltage to the head, the voltage changing the flying height between the head and the magnetic disk from the first distance to a second distance; delivering a radiation to the magnetic disk through the near field transducer, the radiation heating the near field transducer and changing the flying height from the second distance to a third distance; and altering the voltage to the head to change the flying height to the second distance.

### CONCLUSION

Embodiments described herein generally relate to use of interface voltage control to control for short transient changes in flying height in a head. When radiation is delivered thought the NFT, the NFT heats up. This heating can lead to a transient extension from the air bearing surface toward the magnetic disk. Interface voltage control can be used to compensate the potential difference between head and disk. The voltage can be supplied to the entire slider body or to the magnetic head and therefore will automatically produce an attractive force. This attractive force is used to control the flying height, i.e., the distance between the head and disk. By controlling the interface voltage between the head and the magnetic disk in response to changes in the NFT, the distance between the head and the disk can be tightly and responsively controlled during write operations.

In order to achieve a fast retract when writing starts (and the NFT starts protruding), the head should be biased first with a proper interface voltage. While applying this bias voltage, the TFC power needs to be reduced accordingly to maintain same clearance. The TFC actuation may occur before, during or after the electrical actuation using the interface voltage control. In one embodiment, the TFC power could retract first and then the interface voltage can then be applied. When the NFT starts protruding, the voltage is reduced in a controlled fashion to keep the actual HMS constant. As soon as the transient extension has diminished, the TFC can overtake the compensation, allowing the interface voltage to return to a nominal value or a starting value.

While the foregoing is directed to embodiments of the present invention, other and further embodiments of the invention may be devised without departing from the basic scope thereof, and the scope thereof is determined by the claims that follow.

1. A method for controlling flying height comprising:
positioning a head at a flying height which is a first distance from a magnetic disk, the head comprising a near field transducer;
applying a voltage to the head, the voltage changing the flying height between the head and the magnetic disk from the first distance to a second distance less than the first distance;
delivering a radiation to the magnetic disk through the near field transducer, the radiation heating the near field transducer and changing the flying height from the second distance to a third distance less than the second distance; and
altering the voltage to the head to change the flying height to the second distance.

2. The method of claim 1, wherein the second distance is between 1 nm and 10 nm.

3. The method of claim 2, wherein the second distance is between 2 nm and 4 nm.

4. The method of claim 1, wherein the voltage is applied to the head is less than 2V.

5. The method of claim 1, wherein the second distance is between 0.5 nm and 1 nm less than the third distance.

6. The method of claim 1, wherein altering the voltage occurs simultaneously with delivering the radiation.

7. The method of claim 1, wherein the change in flying height from the third distance to the second distance occurs in less than 5 μs from the alteration in voltage.

8. The method of claim 1, wherein the power to the TFC is reduced prior to applying the voltage to the head or the magnetic disk.

9. The method of claim 1, wherein the voltage is delivered by direct current.

10. The method of claim 1, further comprising using the TFC in combination with the voltage to change the flying height to the second distance from the third distance.

11. The method of claim 1, wherein the alteration of the voltage occurs prior to delivering the radiation.

12. A method for controlling flying height comprising:
delivering an electrical bias to a head, the head comprising:
a first surface facing a magnetic disk; and
a near field transducer positioned at the first surface at a first distance from the magnetic disk;
delivering radiation to the magnetic disk through the near-field transducer, the near field transducer changing shape in response to the radiation, wherein the near field transducer is positioned at a second distance from the magnetic disk, wherein the second distance is less than the first distance; and
reducing the electrical bias to the head to move the near field transducer to a flying height which is a third distance from the magnetic disk, wherein the third distance is greater than the second distance and less than the first distance.

13. The method of claim 12, wherein the first distance is between 1 nm and 10 nm.

14. The method of claim 13, wherein the first distance is between 2 nm and 4 nm.

15. The method of claim 12, wherein the electrical bias is applied at a voltage of less than 2V.

16. The method of claim 12, wherein the change in shape of the near field transducer is a transient protrusion, and wherein the second distance is the sum of the first distance and the transient protrusion

17. The method of claim 12, wherein the electrical bias is reduced fluidly with the delivery of radiation through the near field transducer to transition to the third distance.

18. The method of claim 12, further comprising transitioning from the electrical bias to a TFC to maintain the third distance.

19. The method of claim 12, further comprising using the TFC in combination with the voltage to change the flying height to the third distance.

20. A system for controlling flying height, the system comprising at least one processing unit, wherein the processing unit is adapted to perform the following process:
positioning a head at a flying height which is a first distance from a magnetic disk, the head comprising a near field transducer;
applying a voltage to the head, the voltage changing the flying height between the head and the magnetic disk from the first distance to a second distance less than the first distance;
delivering a radiation to the magnetic disk through the near field transducer, the radiation heating the near field transducer and changing the flying height from the second distance to a third distance less than the second distance; and
altering the voltage to the head to change the flying height to the second distance.
